(19) United States
(12) Patent Application Publication
(10) Pub. No.: US 2025/0145528 A1
(43) Pub. Date: May 8, 2025

(54) THE USE OF A POLYMER COMPRISING SIDE CHAINS HAVING A STERICALLY HINDERED AMINE AS CHEMICAL ADMIXTURE FOR A CEMENTITIOUS MATERIAL

(71) Applicant: UNIVERSITEIT GENT, Gent (BE)

(72) Inventors: Richard Hoogenboom, Terneuzen (NL); Metwally Muhammad, Gent (BE); Geert De Schutter, Erpe-Mere (BE); Karel Lesage, Nazareth (BE)

(21) Appl. No.: 18/693,079

(22) PCT Filed: Sep. 19, 2022
(86) PCT No.: PCT/EP2022/075953

§ 371 Date: Mar. 18, 2024

(30) Foreign Application Priority Data
Sep. 21, 2021 (EP) 21197878.8

(51) Int. Cl. C04B 24/26; C08F 293/00

(52) U.S. Cl. CPC C04B 24/2652; C08F 293/005; C08F 2438/03

(57) ABSTRACT

The present disclosure relates to the use of a polymer as chemical admixture, in particular, as superplasticizer, in a cementitious material. The polymer has a backbone structure provided with a plurality of negatively charged groups and provided with a plurality of side chains. at least part of the side chains comprises a pendent group having a sterically hindered amine. The disclosure further relates to a cementitious composition comprising a chemical admixture, in particular, a superplasticizer.

### CROSS REFERENCE TO RELATED APPLICATIONS

This application is a national phase entry under 35 U.S.C. § 371 of International Patent Application PCT/EP2022/075953, filed Sep. 19, 2022, designating the United States of America and published as International Patent Publication WO 2023/046628 A1 on Mar. 30, 2023, which claims the benefit under Article 8 of the Patent Cooperation Treaty to European Union Patent Application Serial No. 21197878.8, filed Sep. 21, 2021.

### TECHNICAL FIELD

The present disclosure relates to the use of a polymer as chemical admixture, in particular, as superplasticizer, in a cementitious material. The polymer comprises a polymer having a backbone structure provided with a plurality of negatively charged groups and provided with a plurality of side chains having a sterically hindered amine. The disclosure further relates to a cementitious composition comprising the polymer as chemical admixture, in particular, as superplasticizer.

### BACKGROUND

Chemical admixtures are commonly used in concrete technology to enhance properties such as durability, flowability, setting and mechanical performance. Among these chemical admixtures, superplasticizers are mainly used to enhance the flowability at a relatively low water-cement (w/c) ratio. First generations of superplasticizers comprise sulfonated naphthalene formaldehyde condensates (SNF) and amino sulphonate-formaldehyde condensates (ASF). They disperse cement particles via an electrostatic repulsion mechanism. A newer generation of superplasticizers comprises polycarboxylate ether (PCE) copolymers. PCE copolymers are comb-like polymers having a backbone provided with carboxylate groups and provided with linear poly(ethylene oxide) (PEO) side chains. Because of their excellent performance, PCE superplasticizers have become the most promising family of superplasticizers. The molecular weight and side-chain length can be easily tailored for specific applications.

PCE copolymers can create both electrostatic repulsion and steric hindrance. The carboxylate groups (COO⁻) interact with the surface of cement grains, resulting in adsorption of the polymer to the cement grain via electrostatic attraction. The main function of the PEO side chains is to exert steric hindrance keeping the cement grains away from each other and hence preventing cement agglomeration. The length of the side chain of PCE superplasticizers can vary substantially and is, for example, chosen in function of the application it is developed for. The PCE superplasticizers typically have side chains having a length of 1 to 50 repeating ethylene oxide units.

The first PCE superplasticizers on the market showed significant problems regarding excessive formation of air bubbles. Although more recently introduced PCE superplasticizers show improvements regarding air bubble formation, excessive formation of air bubbles remain critical, in particular, when the dosage of the superplasticizer is on the higher side.

PCE superplasticizers furthermore have the drawback to be less efficient in the presence of some clay fines due to fast and irreversible adsorption.

Furthermore, many PCE superplasticizers known in the art show rapid slump loss.

As overdosage of PCE superplasticizers, in particular, of bulky PCE superplasticizers, may result in a dramatic change of the viscosity of the suspending medium, making the concrete flow like gum, the dosage of PCE superplasticizers is critical.

### BRIEF SUMMARY

Provided is the use of a polymer having a backbone structure and provided with negatively charged groups and with side chains comprising a pendent group comprising a sterically hindered amine as chemical admixture in a cementitious material, in particular, as superplasticizer, avoiding the problems of the prior art.

Provided is the use of such polymer as chemical admixture in a cementitious material having side chains comprising an amine group, for example, a bulky amine group.

Also provided is a superplasticizer enhancing the dispersion and workability of cementitious material by adsorption and steric repulsion mechanisms.

Further provided is a superplasticizer having an improved air stabilizing effect, in particular, compared to PCE superplasticizers known in the art.

Also provided is a superplasticizer showing robustness toward overdosage and/or slump retention.

Further provided is a superplasticizer that can be added to cementitious materials in solid form during the mixing process, enabling easy dosage and avoiding over-dosage problems.

Further provided is a superplasticizer maintaining excellent workability over time.

Further provided is a method to prepare superplasticizers.

Also provided is the use of a superplasticizer as chemical admixture in cementitious materials.

According to a first aspect of the present disclosure, the use of a polymer as chemical admixture in a cementitious material, in particular, as superplasticizer in cementitious material, is provided. The polymer comprises a backbone structure having a plurality of negatively charged groups and having a plurality of side chains. At least part of the side chains comprises a pendent group having a sterically hindered amine. The pendent group having the sterically hindered amine comprises:
a group of formula (I) or of formula (II)

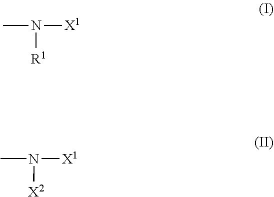

with
—X¹, —X² comprising a substituted or non-substituted alkyl having 3 to 20 carbon atoms. This substituted or non-substituted alkyl has a secondary or tertiary carbon atom directly attached to the nitrogen atom of the group of formula (I) or of formula (II);
—R¹ comprising hydrogen or a substituted or non-substituted alkyl having 1 to 20 carbon atoms;
or
a group comprising a heterocyclic amine A having a sterically hindered nitrogen. The heterocyclic amine A comprises at least one (saturated or unsaturated) closed ring comprising carbon atoms and at least one nitrogen atom in the (saturated or unsaturated) closed ring. The at least one nitrogen atom of the closed ring has at least one carbon atom being directly attached to the at least one nitrogen atom of the closed ring and being part of the closed ring that is substituted with at least one substituted or non-substituted alkyl having 1 to 20 carbon atoms, preferably having 1 to 10 carbon atoms, for example, 1 to 5 carbon atoms.

The negatively charged groups are present in an amount of x mol %, with x being at least 10. The side chains comprising the pendent group having the sterically hindered amine are present in an amount of at least 0.80·(100−x) mol %.

In particular embodiments, the negatively charged groups are present in an amount of at least 20 mol %, at least 30%, at least 40 mol %, at least 50 mol %, at least 70 mol %, at least 80 mol % or at least 90 mol %.

In preferred embodiments, the negatively charged groups are present in an amount ranging between 30 and 90 mol % or between 40 and 80 mol %.

In particular embodiments, the side chains comprising a pendent group having the sterically hindered amine are present in an amount of at least 0.85·(100−x) mol %, at least 0.90·(100−x) mol %. at least 0.95·(100−x) mol %. In a particular embodiment, the side chains comprising a pendent group having the sterically hindered amine are present in an amount of (100−x) mol %.

It is clear that the backbone may be provided with different types of negatively charged groups and/or with different side chains comprising a pendent group having a sterically hindered amine. A polymer according to the present disclosure may, for example, comprise different side chains having a group of formula (I), different side chains having a group of formula (II) or different side chains having a heterocyclic amine A. A polymer according to the present disclosure may also comprise a combination of side chains having a group of formula (I) and/or side chains having a group of formula (II) and/or side chains having a heterocyclic amine A. Different side chains may have the same length or may have a different length. The pendent group of different side chains may be linked in the same way to the backbone structure or may be linked to the backbone structure by the same linking group or by a different linking group.

In case the backbone is provided with different types of negatively charged groups, the number of negatively charged groups corresponds with the total number of negatively charged groups, i.e., with the sum of the numbers of the different types of negatively charged groups.

Similarly, in case the backbone is provided with different types of side chains comprising a pendent group having a sterically hindered amine, the number of side chains corresponds with the total number of side chains comprising a pendent group, i.e., with the sum of the numbers of the different types of side chains comprising a pendent group having a sterically hindered amine.

In addition to the negatively charged groups and the side chains comprising the pendent groups having the sterically hindered amine, the backbone of the polymer may be provided with additional side chains.

Any side chain not comprising a pendent group having a sterically hindered amine can be considered as an additional group. Examples of additional groups comprise, for example, poly(ethylene oxide) side chains.

However, in case the backbone structure is provided with additional side chains, the amount of additional side chains is limited to a maximum amount as the negatively charged groups are present in an amount of x mol %, with x being at least 10 and the side chains comprising the sterically hindered amine are present in an amount of at least 0.8·(100−x) mol %.

In any case, the molar percentage of side chains comprising a pendent group having a sterically hindered amine is considerably higher than the molar percentage of additional side chains. Preferably, the molar percentage of side chains comprising a pendent groups having a sterically hindered amine is at least 4 times the molar percentage of additional side chains. In particular embodiments, the molar percentage of side chains comprising a pendent group having a sterically hindered amine is at least 5 times, at least 6 times, at least 8 times or at least 10 times higher than the molar percentage of the additional side chains.

In preferred embodiments, the backbone structure of the polymer is not provided with side chains comprising poly(ethylene oxide).

As mentioned above, the group of formula (I) comprises a secondary or tertiary sterically hindered amine.
—X¹ of the group of formula (I) comprises an alkyl having 3 to 20 carbon atoms, preferably 3 to 10 atoms, for example, 3 to 5 carbon atoms, having a secondary or tertiary carbon atom directly attached to the nitrogen atom of the group of formula (I). The alkyl may be substituted or non-substituted.

Preferably, —X¹ comprises a branched alkyl, a secondary alkyl, a tertiary alkyl or an isoalkyl. The branched alkyl, secondary alkyl, tertiary alkyl or isoalkyl can be substituted or non-substituted.

Examples of secondary alkyls comprise secondary butyl, secondary pentyl or secondary hexyl. An example of a tertiary alkyl comprises tertiary butyl. An example of an isoalkyl comprises isopropyl.

Examples of substituted alkyls comprise hydroxyalkyls, aminoalkyls, ethers, carboxylates or amides.

—R¹ comprises, for example, a hydrogen or an alkyl or substituted alkyl having 1 to 20 carbon atoms, for example, having 1 to 10 atoms, for example, 2 to 4 carbon atoms. —R¹ may comprise a linear or branched alkyl. In preferred examples —R¹ comprises hydrogen, methyl or ethyl.

Preferred groups of formula (I) are given below:

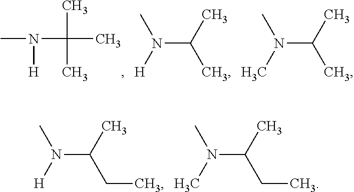

The compounds of formula (II) comprise a tertiary sterically hindered amine. —X¹ and —X² of the group of formula (II) comprise an alkyl having 3 to 20 carbon atoms, preferably 3 to 10 atoms, for example, 3 to 5 carbon atoms, having a secondary or tertiary carbon atom directly attached to the nitrogen atom of the group of formula (II). The alkyl may be substituted or non-substituted.

Preferably, —X¹ and/or —X² comprise a branched alkyl, a secondary alkyl, a tertiary alkyl or an isoalkyl. The branched alkyl, secondary alkyl, tertiary alkyl or isoalkyl can be substituted or non-substituted. —X¹ and —X² can be chosen independently from each other and can be the same or can be different.

Examples of secondary alkyls comprise secondary butyl, secondary pentyl or secondary hexyl. An example of a tertiary alkyl comprises tertiary butyl. An example of an isoalkyl comprises isopropyl.

Examples of substituted alkyls comprise hydroxyalkyls, aminoalkyls, ethers, carboxylates or amides.

A preferred group of formula (II) comprises amine having two isopropyl groups:

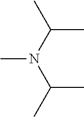

The heterocyclic amine A comprises at least one closed ring comprising carbon atoms and at least one nitrogen atom in the closed ring. The closed ring comprises at least one carbon atom that is directly attached to the at least one nitrogen atom of the closed ring and that is part of the closed ring. The at least one carbon atom being part of the closed ring that is directly attached to the at least one nitrogen atom is substituted with at least one substituted or non-substituted alkyl having 1 to 20 carbon atoms, preferably having 1 to 10 carbon atoms, for example, 1, 2 or 3 carbon atoms.

In preferred embodiments, both carbon atoms directly attached to the nitrogen atom of the closed ring and being part of the closed ring are substituted with an alkyl, either a substituted or non-substituted alkyl, having 1 to 20 carbon atoms, preferably having 1 to 10 carbon atoms, for example, 1, 2 or 3 carbon atoms. Both carbon atoms directly attached to the nitrogen atom of the closed ring and being part of the closed ring are, for example, substituted with a methyl group.

In other preferred embodiments, a carbon atom directly attached to the nitrogen atom of the closed ring and being part of the closed ring is substituted with two alkyls, either substituted or non-substituted alkyls, having 1 to 20 carbon atoms, preferably having 1 to 10 carbon atoms, for example, 1, 2 or 3 carbon atoms. A carbon atom directly attached to the nitrogen atom of the closed ring and being part of the closed ring is, for example, substituted with two methyl groups.

In further preferred embodiments, both carbon atoms directly attached to the nitrogen atom of the closed ring and being part of the closed ring are substituted with two alkyls, either substituted or non-substituted alkyls, having 1 to 20 carbon atoms, preferably having 1 to 10 carbon atoms, for example, 1, 2 or 3 carbon atoms. Both carbon atoms directly attached to the nitrogen atom of the closed ring and being part of the closed ring are, for example, substituted with two methyl groups.

The closed ring of the heterocyclic amine A may comprise a saturated or unsaturated ring. For the purpose of this disclosure, unsaturated rings include partially unsaturated rings.

The group comprising the heterocyclic amine A may comprise more than one closed ring, for example, two closed rings.

The number of atoms (members) of a closed ring preferably ranges between 4 and 20, more preferably between 5 and 10. Particularly preferred closed rings are rings having 5 or 6 atoms (members).

The closed ring comprises at least one nitrogen atom in the closed ring. In particular embodiments, the closed ring comprises one nitrogen atom in the closed ring. Possibly, the closed ring comprises more than one nitrogen atom in the closed ring, for example, two or three nitrogen atoms.

In addition to the at least one nitrogen atom, the closed ring may comprise one or more other heteroatoms, for example, one or more oxygen atom and/or one or more sulfur atoms.

Examples of five-membered rings having one nitrogen atom in the five-membered ring comprise pyrrolidine (saturated) and pyrrole (unsaturated).

Examples of five-membered rings with two nitrogen atoms in the five-membered rings comprise imidazolidine (saturated), pyrazolidine (saturated), imidazole (unsaturated) and pyrazole (unsaturated).

Examples of six-membered rings having one nitrogen atom comprise piperidine (saturated) and pyridine (unsaturated).

Examples of six-membered rings having two nitrogen atoms comprise diazinane (saturated) and diazine (unsaturated).

Examples of six-membered rings having three nitrogen atoms comprise triazinane (saturated) and triazine (unsaturated).

Examples of seven-membered rings having one nitrogen atom comprise azepane (saturated) and azepine (unsaturated).

Examples of seven-membered rings having two nitrogen atoms comprise diazepane (saturated) and diazepine (unsaturated).

Examples of eight-membered rings having one nitrogen atom comprise azocane (saturated) and azocine (unsaturated).

A schematic illustration of a heterocyclic amine A comprising a six-membered saturated ring having one nitrogen atom in the closed ring is given below:

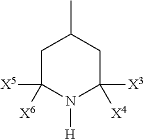

with at least one of —X³, —X⁴, —X⁵, —X⁶ comprising an alkyl, either a substituted or non-substituted alkyl, having 1 to 20 carbon atoms, preferably having 1 to 10 carbon atoms, for example, 1, 2 or 3 carbon atoms.

In case —X³, —X⁴, —X⁵, —X⁶ does not comprise an alkyl, —X³, —X⁴, —X⁵, —X⁶ preferably comprises hydrogen.

In preferred embodiments, at least one of —X³ or —X⁴ comprises an alkyl and at least one of —X⁵ or —X⁶ comprises an alkyl, for example, methyl or ethyl.

In other preferred embodiments, both —X³ and —X⁴ comprise an alkyl and/or both —X⁵ and —X⁶ comprise an alkyl, for example, methyl or ethyl or a combination of methyl and ethyl.

In further preferred embodiments, both —X³ and —X⁴ comprise an alkyl and both —X⁵ and —X⁶ comprise an alkyl, for example, methyl or ethyl or a combination of methyl and ethyl.

A preferred heterocyclic amine A comprises 2,2,6,6-tetramethylpiperidine:

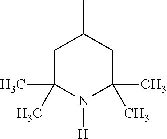

As mentioned above, the backbone structure of the polymer according to the present disclosure is provided with negatively charged groups. The negatively charged groups may interact with the surface of the cement particles, preferably via electrostatic attraction.

Any negatively charged group that may interact with the surface of the cement particles can be considered. Preferred negatively charged groups are selected from the group consisting of carboxylates, sulfonates, phosphonates and combinations thereof. The backbone structure of the polymer can be provided with one type of negatively charged groups, for example, with carboxylates or can be provided with different types of negatively charged groups, for example, with carboxylates and sulfonates.

The group of the side chain comprising the sterically hindered amine (i.e., comprising the group of formula (I), the group of formula (II) of the group comprising the heterocyclic amine A) is preferably linked to the backbone structure by a chemical bond or by a linking group —Z—, —Y—, —Y¹—Z—, —Z—Y²— or —Y¹—Z—Y²—
with
—Z— comprising a linking group of formula (IV), formula (V) or formula (VI)

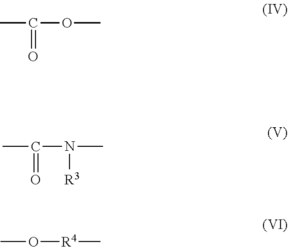

—R³ comprising hydrogen or a substituted or non-substituted hydrocarbyl having a chain and/or ring structure comprising carbon atoms and hydrogen atoms and possibly comprising at least one heteroatom;
—R⁴— comprising a substituted or non-substituted hydrocarbyl having a chain and/or ring structure comprising carbon atoms and hydrogen atoms and possibly comprising at least one heteroatom;
—Y—, —Y¹—, —Y²— comprising a substituted or non-substituted hydrocarbyl having a chain and/or ring structure comprising carbon atoms and hydrogen atoms and possibly comprising at least one heteroatom.

It is clear that —Y¹— and —Y²— can be chosen independently from each other. —Y¹— and —Y²— can be the same or can be different.

—R³ comprises preferably hydrogen, methyl or ethyl.

—R⁴— comprises preferably an alkyl, an alkenyl, a substituted alkyl or a substituted alkenyl. Preferably, —R⁴— comprises ethyl, propyl, butyl or vinyl.

For the purpose of this disclosure, the term “hydrocarbyl” refers to a chain and/or ring structure comprising carbon atoms and hydrogen atoms and possibly comprising at least one heteroatom in the ring and/or chain structure. The number of carbon atoms is, in principle, not limited, but ranges preferably between 1 and 200 carbon atoms, for example, between 1 and 30 carbon atoms, for example, between 1 and 10 carbon atoms or between 1 and 5 carbon atoms. The hydrocarbyl can be linear or branched, cyclic or acyclic, saturated or unsaturated, aliphatic (for example, alkyls or alkenyls), alicyclic (for example, cycloalkyls or cycloalkenyls) or aromatic. The hydrocarbyls can be substituted or non-substituted. Although hydrocarbyls predominantly comprise carbon and hydrogen, hydrocarbyls may include one or more heteroatoms in the ring and/or chain structure, for example, sulfur, oxygen and/or nitrogen. Preferably, the number of heteroatoms of a hydrocarbyl is maximum one for every 4 carbon atoms, preferably maximum one for every 6 carbon atoms, or maximum one for every 10 carbon atoms. Hydrocarbyls comprise, for example, one or more functional groups, for example, one or more functional groups selected from ether (—O—), thioether (—S—), disulfide (—S—S), ester (—C(O)—O—), amide (—C(O)—NH—), carbamate (—NH—C(O)—O—), urea (—NH—C(O)—NH—), and mixtures thereof. Preferably, the number of heteroatoms of a hydrocarbyl is maximum one for every 4 carbon atoms, preferably maximum one for every 6 carbon atoms, or maximum one for every 10 carbon atoms.

In case the group comprising the sterically hindered amine, i.e., the group of formula (I), the group of formula (II) or the heterocyclic amine A, is linked to the backbone structure by means of a chemical bond, such chemical bond is preferably a covalent bond. In such case, the group of formula (I), the group of formula (II) or the heterocyclic amine A is, for example, directly linked, i.e., by means of the chemical bond, to the backbone structure.

In case the group of formula (I), the group of formula (II) or the heterocyclic amine A is linked by a linking group —Z—, preferred linking groups comprise

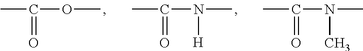

or an ethoxyalkyl, such as ethoxyethyl.

In case the group of formula (I), the group of formula (II) or the heterocyclic amine A is linked by linking group —Y—, some preferred groups —Y— are alkyls (for example, ethyl, propyl or butyl), substituted alkyls, alkenyls (for example, vinyl) or substituted alkenyls.

In case the group of formula (I), the group of formula (II) or the heterocyclic amine A is linked by linking group —Y¹—Z—, —Y¹— comprises, for example, an alkyl (for example, ethyl, propyl or butyl), a substituted alkyl, an alkenyl (for example, vinyl), a substituted alkenyl, an ethoxyalkyl (such as ethoxyethyl or ethoxypropyl) and —Z— comprises, for example,

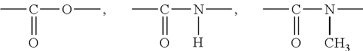

or an ethoxyalkyls (such as ethoxyethyl). Particularly preferred —Y¹—Z— groups comprise ethyl, propyl or ethoxyethyl as —Y¹— group and

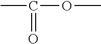

as —Z— group.

In case the group of formula (I), the group of formula (II) or the heterocyclic amine A is linked by linking group —Z—Y²—, Z— comprises, for example,

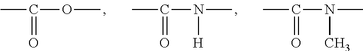

or an ethoxyalkyls (such as ethoxyethyl) and —Y²— comprises, for example, an alkyl (for example, ethyl, propyl or butyl), a substituted alkyl, an alkenyl (for example, vinyl), a substituted alkenyl, an ethoxyalkyl (such as ethoxyethyl or ethoxypropyl). Particularly preferred, —Z—Y²— groups comprise

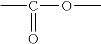

as —Z-group and ethyl, propyl or ethoxyethyl as —Y²— group.

In case tie group of formula (I), the group of formula (II) or the heterocyclic amine A is linked by linking group —Y¹—Z—Y²—, —Y¹— comprises, for example, an alkyl (for example, ethyl, propyl or butyl), a substituted alkyl, an alkenyl (for example, vinyl), a substituted alkenyl, an ethoxyalkyl (such as ethoxyethyl or ethoxypropyl); —Z— comprises, for example,

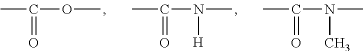

or an ethoxyalkyls (such as ethoxyethyl) and —Y²— comprises, for example, an alkyl (for example, ethyl, propyl or butyl), a substituted alkyl, an alkenyl (for example, vinyl), a substituted alkenyl, an ethoxyalkyl (such as ethoxyethyl or ethoxypropyl). Particularly preferred —Y¹—Z—Y²— groups comprise ethyl, propyl or ethoxyethyl as —Y¹— group,

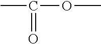

as —Z-group and ethyl, propyl or ethoxyethyl as —Y²— group.

The backbone structure of the polymer may comprise any polymeric backbone structure, for example, a backbone structure obtainable by radical polymerization.

The polymer for use as chemical admixture in a cementitious material according to the present disclosure can be prepared by radical polymerization starting from a first monomer or a comonomer of a first monomer and a second monomer or a comonomer of a second monomer.

The first monomer comprises at least one unsaturated carbon-carbon bond and at least one negatively charged group, preferably at least one carboxylate, sulfonate or phosphonate group. The second monomer comprises at least one unsaturated carbon-carbon bond and at least one pendent group having a sterically hindered amine. The pendent group of the second monomer comprises:
a group of formula (I) or of formula (II)

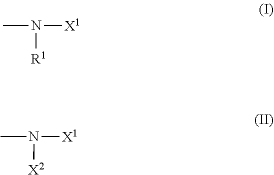

with
—X¹, —X² comprising a substituted or non-substituted alkyl having 3 to 20 carbon atoms. This substituted or non-substituted alkyl having a secondary or tertiary carbon atom directly attached to the nitrogen atom of the group of formula (I) or of formula (II);
—R¹ comprising hydrogen or a substituted or non-substituted alkyl or substituted alkyl having 1 to 20 carbon atoms;
or
a group comprising a heterocyclic amine A having a sterically hindered nitrogen. The heterocyclic amine A comprises at least one (saturated or unsaturated) closed ring comprising carbon atoms and at least one nitrogen atom in the (saturated or unsaturated) closed ring. The at least one nitrogen atom of the closed ring has at least one carbon atom being directly attached to the at least one nitrogen atom of the closed ring and being part of the closed ring that is substituted with at least one substituted or non-substituted alkyl having 1 to 20 carbon atoms, preferably having 1 to 10 carbon atoms, for example, 1 to 5 carbon atoms.

The first monomer or comonomer of the first monomer is present in an amount of at least x mol %, with x being at least 10.

The second monomer or comonomer of second monomer is present in an amount of at least 0.8·(100−x) mol %.

It is clear that the method according to the present disclosure may comprise radical polymerization starting from a combination of a first monomer and a comonomer of this first monomer and/or from a combination of a second monomer and a comonomer of this second monomer.

The first monomer (or comonomer of the first monomer and the second monomer (or comonomer of the second monomer)) are preferably present in a ratio of first monomer/second monomer ranging between 95/5 and 5/95, more preferably in a ratio (mol %) ranging between 90/10 and 25/75 or even more preferably in a ratio ranging between 90/10 and 40/60.

A preferred method comprises free radical polymerization starting from (meth)acrylic acid as first monomer and 2,2,6,6 tetramethyl-4-piperidyl methacrylate (TMPMA) as the second monomer. The first monomer and the second monomer are preferably present in a ratio (mol %) ranging between 90/10 and 25/75 or even more preferably ranging between 90/10 and 40/60, for example, in a ratio of 50/50.

A preferred method to prepare the superplasticizer according to the present disclosure comprises reversible addition-fragmentation chain transfer (RAFT) polymerization. A particular method according to the present disclosure comprises RAFT polymerization starting from (meth)acrylic acid as the first monomer and 2,2,6,6-tetramethyl-4-piperidyl methacrylate (TMPMA) as the second monomer.

According to a further aspect of the present disclosure, a cementitious composition comprising a superplasticizer as described above is provided. The cementitious composition comprises a cementitious material and a chemical admixture. The chemical admixture comprises a polymer having a backbone structure being provided with a plurality of negatively charged groups and being provided with a plurality of side chains. The side chains comprise a pendent group having a sterically hindered amine, with the pendent group comprising:
a group of formula (I) or of formula (II)

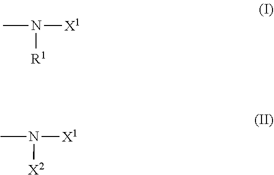

with
—X¹, —X² comprising a substituted or non-substituted alkyl having 3 to 20 carbon atoms and having a secondary or tertiary carbon atom directly attached to the nitrogen atom of the group of formula (I) or of formula (II);
—R¹ comprising hydrogen or a substituted or non-substituted alkyl having 1 to 20 carbon atoms;
or
a heterocyclic amine A comprising at least one saturated or unsaturated closed ring comprising carbon atoms and at least one nitrogen atom in the saturated or unsaturated closed ring, with the at least one nitrogen atom of the closed ring having at least one carbon atom being part of the closed ring that is directly attached to the at least one nitrogen atom and that is substituted with at least one alkyl or substituted alkyl having 1 to 20 carbon atoms;

The negatively charged groups are present in an amount of x %, with x being at least 10. The side chains comprising a pendent group having a sterically hindered amine are present in an amount of at least 0.80·(100−x) mol %.

In particular embodiments, the negatively charged groups are present in an amount of at least 20 mol %, at least 30%, at least 40 mol %, at least 50 mol %, at least 70 mol %, at least 80 mol % or at least 90 mol %.

In particular embodiments, the side chains comprising a pendent group having the sterically hindered amine are present in an amount of at least 0.85·(100−x) mol %, at least 0.90·(100−x) mol %. at least 0.95·(100−x) mol %. In a particular embodiment, the side chains comprising a pendent group having the sterically hindered amine are present in an amount of (100−x) mol %.

The superplasticizer according to the present disclosure can be added to cementitious material in solid form or as a solution, for example, during the mixing process. In some embodiments, it is preferred to add the superplasticizer in solid form to the cementitious material as this enables easy dosage and may avoid over-dosage problems.

### BRIEF DESCRIPTION OF THE DRAWINGS

The present disclosure will be discussed in more detail below, with reference to the attached drawings, in which:

FIG. 1 schematically illustrates the function of a superplasticizer according to the present disclosure;

FIG. 2 shows the synthesis of a polymer for use as superplasticizer according to the present disclosure by RAFT copolymerization of methacrylic acid (MAA) and 2,2,6,6-tetramethyl-4-piperidyl methacrylate (TMPMA) to form poly(MAA co-TMPMA) polycarboxylate (PCA) amines;

FIG. 3 shows the shear stress versus the shear rate of cement with poly(MAAₓ-co-TMPMA_{y}) PCA superplasticizers compared to reference cement paste without superplasticizer;

FIGS. 4(a) and 4(b) show the effect of PCA composition on (a) mini-slump, and (b) relative slump of cement pastes containing 0.1% bwoc PCA copolymers. The ratios refer to the theoretical MAA/TMPMA ratio in the PCA superplasticizers;

FIG. 5 shows the shear stress vs. shear rate of cement with the poly(MAA75-co-TMPMA25)^{FRP} PCA superplasticizer at different polymer concentrations at W/C=0.35;

FIG. 6 shows the spread diameter over time for cement with poly(MAA75-co-TMPMA25)FRP; W/C=0.35 and a polymer concentration of 0.1% (bwoc) compared with 0.1% Master Glenium 27 as a benchmark commercial superplasticizer (W/C=0.35);

FIG. 7 shows the results of a Mini-slump test of cement pastes containing 0.3% bwoc copolymers and compared to Master Glenium 27 at W/C=0.35 using a mini-cone (height 25 mm, bottom diameter 30 mm, and a top diameter 10 mm). The spread diameter was measured directly after removing the mini-come without shaking the jolting table.

### DETAILED DESCRIPTION

The present disclosure will be described with respect to particular embodiments and with reference to certain drawings, but the disclosure is not limited thereto but only by the claims. The drawings are only schematic and are non-limiting. The size of some of the elements in the drawing may be exaggerated and not drawn on scale for illustrative purposes. The dimensions and the relative dimensions do not correspond to actual reductions to practice of the disclosure.

When referring to the endpoints of a range, the endpoints values of the range are included.

When describing the disclosure, the terms used are construed in accordance with the following definitions unless indicated otherwise.

The term ‘and/or’ when listing two or more items, means that any one of the listed items can by employed by itself or that any combination of two or more of the listed items can be employed.

The term ‘monomer’ refers to small molecules that can react with other similar or different molecules to form a larger polymer chain or network.

The term ‘comonomer’ refers to a group of monomers that can react with other similar or different molecules (for example, with other similar or different monomers or comonomer) to form a larger polymer chain or network consisting of two or more types of monomers.

For the purpose of this disclosure the term ‘cementitious material’ refers to materials comprising cement as, for example, concrete or mortar and includes fresh cementitious material, partially or fully hardened cementitious material. For a person skilled in the art, it is clear that cementitious material may comprise water and/or aggregates. Cementitious material may further comprise other additional components and/or additives, such as additional components and/or additives known in the art, in particular, mineral additional components and/or additives, for example, mineral additional components and/or additives in powder form.

The term “cement” refers to materials capable of binding aggregate particles together and includes hydraulic cement as well as supplementary cementitious materials (SCMs). The term ‘cement’ refers, for example, to Portland cement, calcium aluminate cement, lime, gypsum, geopolymer cement or other inorganic binders.

The term “aggregates” refers to granular materials and comprises, for example, sand, gravel, crushed stones and iron blast-furnace slag. The granular material preferably has an average particle size that is several times larger than the average particle size of the cement particles.

The term “secondary carbon” refers to a carbon atom bound to two other carbon atoms, the term “tertiary carbon” refers to a carbon atom bound to three other carbon atoms.

The term “secondary alkyl” refers to an alkyl in which the carbon atom bearing the unpaired electron is bound to two carbon atoms; the term “tertiary alkyl” refers to an alkyl in which the carbon atom bearing the unpaired electron is bound to three carbon atoms.

The term “isoalkyl” refers to a radical of an isoalkane, with the term “isoalkane” referring to a branched alkane having one branch point, having one hydrogen atom on the branch point and having at least two methyl groups on the branch point.

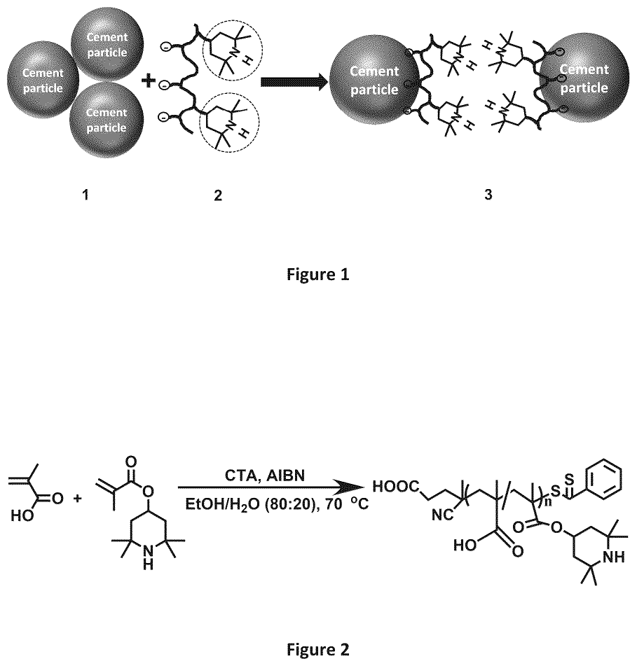

FIG. 1 schematically illustrates the function of the superplasticizer 2 according to the present disclosure. Agglomerated particles 1 are mixed with the superplasticizer 2 according to the present disclosure. The negatively charged groups of the superplasticizer 2 interact with the surface of the cement particles 1, whereas the side chains comprising the pendent group having a sterically hindered amine provide steric hinderance resulting in dispersed cement particles 3 thereby preventing agglomeration of the cement particles.

### EXPERIMENTAL RESULTS

Superplasticizers according to the present disclosure were successfully prepared starting from different monomer compositions. The superplasticizers according to the present disclosure are also referred to as polycarboxylate amine (PCA) superplasticizers.

The rheological behavior of the superplasticizers was examined. Mini-slump tests were performed to study the initial dispersion performance and slump retention performance upon the addition of these novel PCA polymers.

### Example 1

### 1. Materials and Methods

### 1.1. Materials

All chemicals and solvents used were commercially available and used as received unless otherwise stated.

Methacrylic acid (MAA, Aldrich) was purified by passing the monomer over a basic alumina oxide column.
2,2,6,6, tetramethyl-4-piperidyl methacrylate (TMPMA, TCI chemicals) was used as received.
4-cyano-4-thiothiopropyl-sulfanyl pentanoic acid (CTPPA, Aldrich) was used as the chain transfer agent (CTA).
Methanol (MeOH), ethanol (EtOH), and trioxane were provided by Sigma-Aldrich.
Azobis(isobutyronitrile) (AIBN, Aldrich) was recrystallized from MeOH.

### 1.2. Synthesis of Poly(MAA-Co-TMPMA) Superplasticizers by Reversible Addition-Fragmentation Chain Transfer (RAFT) Polymerization

Different compositions of poly(MAAₓ-co-TMPMA_{y}), with varying x and y, were successfully prepared by RAFT polymerization. As an example, the poly(MAA₅₀-co-TMPMA₅₀) copolymer was prepared as follows: MAA (848 μL, 10 mmol, 50 eq.), TMPMA (2.25 g, 10 mmol, 50 eq.), CTA (55.9 mg, 0.2 mmol, 1 eq.), and AIBN (6.65 mg, 0.04 mmol, 0.2 eq.) were added in a schlenk tube and then dissolved in 16.9 mL of EtOH/H₂O (80/20). 1,3,5-Trioxane (183.8 mg, 2 mmol) was added as an internal standard for the determination of the monomer conversion by ¹H NMR spectroscopy. The solution was bubbled for 20 minutes with argon and then heated to 70° C. in an oil bath and stirred at 600 rpm (revolutions per minute). After 24 hours, the polymerization was quenched by rapid cooling by immersing the flask in an ice water bath. It was found that the obtained polymers were precipitated from the polymerization solution during the polymerization process. Subsequently, the products were collected and filtered and then redissolved in a minimum amount of MeOH or a mixture of MeOH/H₂O (50/50 vol. %), depending on the composition, and precipitated in diethyl ether three times to purify the polymer and finally dried in a vacuum oven at 4° C. for 24 hours. The final polymer products were obtained as orange powders in a yield of 65-90%.

### 1.3. Free Radical Polymerization (FRP) of Poly(MAA75-Co-TMPMA25) Superplasticizers

Poly(MAA75-co-TMPMA25) was prepared by FRP at a monomer to initiator ratio [M]/[I]=10. In a representative example, MAA (0.636 mL, 7.5 mmol) and TMPMA (0.562 g, 2.5 mmol), and AIBN (164 mg, 1 mmol) were dissolved in a mixture of EtOH/H₂O (70/30 vol %). 3-Mercaptopropionic acid (8.3 μL; 0.1 mmol) was used as the chain transfer agent, and the mixture was bubbled with argon for 20 min. The reaction mixture was stirred at 60° C. for 3 h, during which the polymer precipitated. The precipitate was collected through evaporation of the solvent, and the polymer was dried in vacuo at 40° C. overnight. The prepared polymers were used without further purification.

### 1.4. Chemical Modification of the Polymers for Size-Exclusion Chromatography (SEC) Analysis

Due to the difficulty of analyzing the polymers using SEC, the polymers were modified by methylation of the carboxylic acid groups using TMS-diazomethane. Briefly, 50 mg of each sample was dissolved in 10 ml THF/H₂O mixture (1:1). TMS-diazomethane was added to the polymer solution dropwise at room temperature. The addition of the methylation agent was continued until the appearance of the yellow color. An excess of the methylation agent was added, and the solution was further stirred for an additional 3 hours at room temperature. The polymer solutions were finally dried by rotovap to yield a yellowish polymer after the methylation process. ¹H-NMR analysis confirmed quantitative methylation of the polymers.

### 1.5. Characterization

¹H NMR spectroscopy measurements were carried out on a Bruker DRX 400 spectrometer using deuterated dimethyl sulfoxide (DMSO-d₆) as a solvent at room temperature. The chemical shift scale was calibrated relative to the tetramethylsilane peak, used as a reference. ¹H NMR samples were prepared by mixing 0.75 mL of DMSO-d₆ with three drops of the reaction mixture. Size-exclusion chromatography (SEC) was performed on an Agilent 1260-series HPLC system equipped with a 1260 online degasser, a 1260 ISO-pump, a 1260 automatic liquid sampler (ALS), a thermostatted column compartment (TCC) at 50° C. equipped with two 5 μm mixed-D columns having a highly cross-linked, porous polystyrene/divinylbenzene matrix (Agilent PLgel™ 5 μm) and a precolumn in series, a 1260 diode array detector (DAD) and a 1260 refractive index detector (RID). The used eluent was dimethylacetamide (DMA), containing 50 mM of LiCl at a flow rate of 0.500 ml/min. The spectra were analyzed using the Agilent Chemstation™ software with the GPC add-on. Polymer molar mass values and molar mass dispersity (Ð) values were calculated against PMMA standards from Polymer Standards Service—USA Inc.

### 1.6. Cement Paste Preparation

Ordinary Portland Cement (OPC) CEM I 52.5N was used in this study. The water to cement ratio (W/C) was fixed at 0.35 unless otherwise stated. The solid polymers were added to the dry cement, and then followed by water addition. The paste was mixed by hand using a spatula for 180 seconds.

### 1.7. Rheological Study

A parallel-plate rheometer (Anton Paar MCR 102) was used to study the flow behavior of the newly developed superplasticizers. As reported in recent work, a similar protocol is adopted in this study. In brief, the cement pastes were hand-mixed for 180 seconds and transferred to the rheometer plate. A pre-shear of 20 seconds was applied at a shear rate of 175 s⁻¹, followed by a stepwise shear increase from 50 to 175 s⁻¹ and then a decrease to 50 s⁻¹. The steps are taken every 20 seconds with a shear rate steps of 25 s⁻¹. The flow curves were calculated based on the average data obtained from the down curve, and the Bingham model was applied to calculate the rheological parameters (i.e., plastic viscosity and yield stress).

### 1.8. Dispersion Performance

The dispersion performance of the superplasticizer copolymers was evaluated by means of the fluidity of the cement pastes assessed by mini-slump tests. The dry solid polymers (i.e., 0.1% bwoc) were added to the dry cement, and water was then added to obtain a W/C ratio of 0.35. The mixture was mixed for 180 seconds through hand mixing and subsequently poured into a mini-slump cone (height 25 mm, bottom diameter 30 mm, and top diameter 10 mm) placed on a jolting table. The cement paste mini-slump flow diameter was measured in four directions after 25 drops with the jolting table. The arithmetic mean of these measurements was used as the final spread of the mini-slump flow test to evaluate the paste fluidity. To study the slump-retention performance of different superplasticizers, time-dependent paste flow tests were further measured. After the initial mini-slump test, the paste was put back into the beaker and rested for 30 and 60 minutes. Before each measurement, the paste sample was hand-mixed again for 180 seconds, and the slump test was repeated.

### 2. Results and Discussion

### 2.1. Synthesis

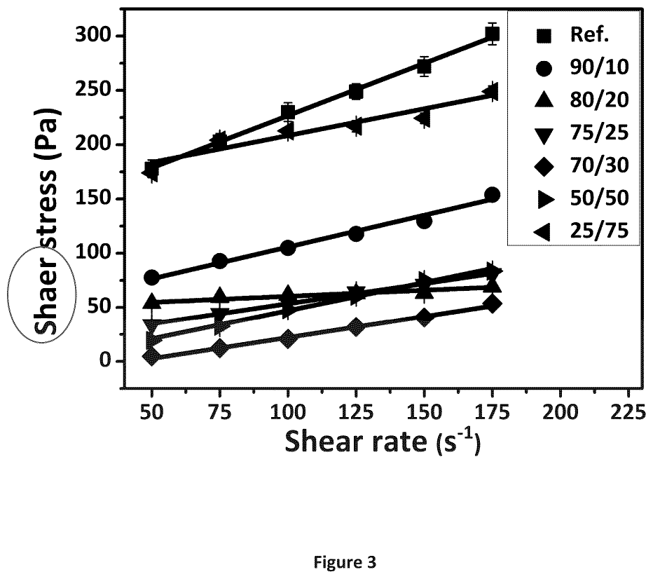

FIG. 2 shows the synthesis of poly(MAAₓ-co-TMPMA_{y}) polymer by RAFT polymerization of methacrylic acid (MAA) and 2,2,6,6-tetramethyl-4-piperidyl methacrylate (TMPMA). Different compositions with varying x and y were prepared to evaluate the effect of monomer composition on the performance of the superplasticizer. The different feed compositions, reaction conditions, and structural details are summarized in Table 1. The prepared copolymers were obtained as solid powders that are soluble in alkaline media. This characteristic enabled their mixing with cement or concrete in solid form and thus precalculated accurate dosages could be used.

TABLE 1
Conditions for PCA synthesis and main structural details of the obtained polymers

| | MAA | TMPMA | Conc. | Time | Conv. | Mₙ^{(SEC)c} | | Size^{e} |
|---|---|---|---|---|---|---|---|---|
| Entry | (mol. %) | (mol. %) | [M] | (h) | (%) | (Kda) | Ð | (nm) |
| 1 | 90 | 10 | 2 | 16 | 85.0 | — | — | 5.48 |
| 2 | 80 | 20 | 2 | 16 | 94.0 | — | — | 6.1 |
| 3 | 75 | 25 | 1 | 16 | 63.6 | 23.3 | 1.18 | 4.80 |
| 4 | 70 | 30 | 1 | 16 | 66.5 | 22.7 | 1.37 | 5.82 |
| 5 | 50 | 50 | 1 | 21 | 86.5 | 33.4 | 1.17 | 5.73 |
| 6 | 23 | 75 | 1 | 16 | 64.0 | 42.5 | 1.18 | — |

The molar mass of the polymers was determined by SEC. To achieve an accurate determination of the molar mass distribution using DMA SEC, the carboxylic acid groups of MAA were esterified to the corresponding methyl esters in THF/H₂O mixture. However, polymers with a high content of MAA (i.e., 90 or 80 mol. %) were not soluble in the methylation solvent and exhibited limited solubility in DMA (i.e., the SEC eluent); therefore, their molar mass distributions could not be determined. As can be observed from Table 1, SEC measurements showed excellent control over the polymer dispersity (Ð<1.2) except for poly(MAA₇₀-co-TMPMA₃₀) with a polymer dispersity index (PDI) value of 1.37, indicating the formation of relatively well-defined copolymers. Despite that the monomer conversion varies for the different copolymers (Table 1), it is evident that the peaks shift toward lower retention time when increasing the TMPMA molar ratio, which is in agreement with the increase in polymer molar mass with higher TMPMA content. Furthermore, the successful polymerizations were confirmed by ¹H-NMR spectra revealing total monomer conversions of 64 to 94%. The particle size of the polymers was in the range of 5-6 nm representing individual polymer chains, indicating good solubility of the polymers in the cement pore solution (Table 1). Due to the insolubility of the polymers with higher TMPMA content (Table 1, entry 6), their particle size could not be measured.

### 2.2. Rheological Behavior

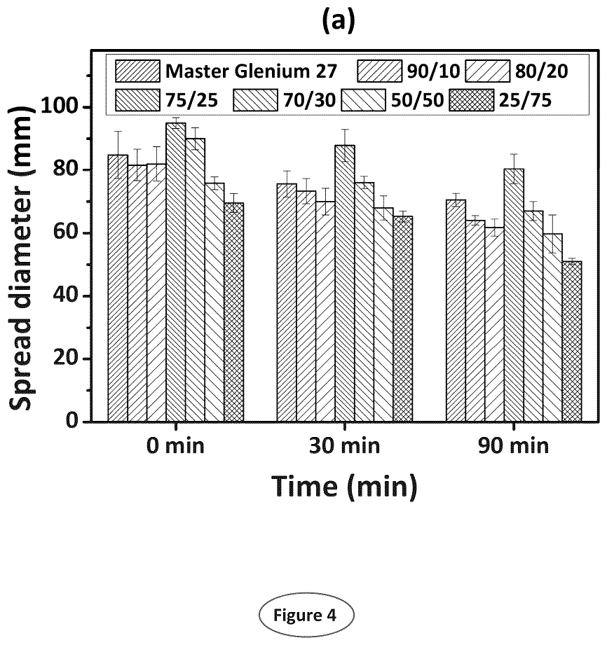

The rheological properties of cement pastes containing different superplasticizers were experimentally studied using a parallel plate rheometer with a diameter of 25 mm and a 2 mm gap between the two plates. The Bingham model was adopted to interpret the results using the linear approximation of the experimental data up to 175 s⁻¹ shear rate. The dynamic yield stress (to) and plastic viscosity (p) of the cement pastes containing different superplasticizers were calculated from the flow curves obtained from the rheometer. FIG. 3 shows the different flow curves of the cement pastes before and after the addition of 0.1% bwoc of the different superplasticizers at a W/C ratio of 0.35. The legend refers to the theoretical MAA/TMPMA ratio in the PCA superplasticizers; the average of 3 measurements was taken.

It can be seen from FIG. 3 that the cement paste without the addition of superplasticizers has a dynamic yield stress of about 130 Pa and plastic viscosity of 0.97 Pa·s. After the addition of poly(MAA90-co-TMPMA10), the rheological properties were significantly improved, as is clear from the decreasing values of both yield stress and plastic viscosity p. A decrease in the yield stress indicates that less external force is required to initiate the flow of the cement paste when the shear rate is zero. When further increasing the content of the TMPMA pendent groups and simultaneously decreasing the MAA anchoring groups, the rheological performance is further improved until a superplasticizer composition of poly(MAA70-co-TMPMA30). Any further increase in the grafting density of TMPMA led to an increase in the values of yield stress and plastic viscosity of the cement pastes, whereby it is shown that poly(MAA25-co-TMPMA75) impairs the rheological behavior of the cement paste. Notably, the addition of the poly(MAA70-co-TMPMA30) PCA to the cement paste led to significantly lower yield stress values than the values that were previously reported for lab-synthesized PCE superplasticizers with different PEO side-chain lengths with a minimum yield stress of 25.5 Pa, at W/C ratio of 0.38, indicating that the superplasticizers according to the present disclosure may outperform the PCE superplasticizers in this aspect. When looking at the plastic viscosity p, it is clear that the viscosity decreases upon the addition of the PCA superplasticizers and that a minimum value is obtained for the poly(MAA80-co-TMPMA20) copolymer.

TABLE 2
Fitting results of the rheological data shown in
FIG. 3 according to Bingham model; Polymer
concentration = 0.1% (bwoc) and W/C = 0.35.

| | Ratio of [MAA]/ | Regression coefficient | | |
|---|---|---|---|---|
| Fluid model | [TMPMA] | τ₀ (Pa) | μ (Pa · s) | R² |
| Bingham model | Ref. | 130 | 0.97 | 0.99 |
| τ = τ₀ + μ\dot{γ} | 90/10 | 47.9 | 0.57 | 0.98 |
| | 80/20 | 50.2 | 0.10 | 0.89 |
| | 75/25 | 16.5 | 0.37 | 0.99 |
| | 70/30 | −16.4* | 0.39 | 0.99 |
| | 50/50 | −6.1* | 0.52 | 0.99 |
| | 25/75 | 157 | 0.50 | 0.88 |

*A negative Bingham's yield stress value is physically impossible. However, it can sometimes occur when linear regression is applied to the experimental points to deduce the Bingham parameters due to the extrapolation of the shear stress corresponding to a zero flow.

### 2.3. Cement Dispersion Performance by the PCA Superplasticizers

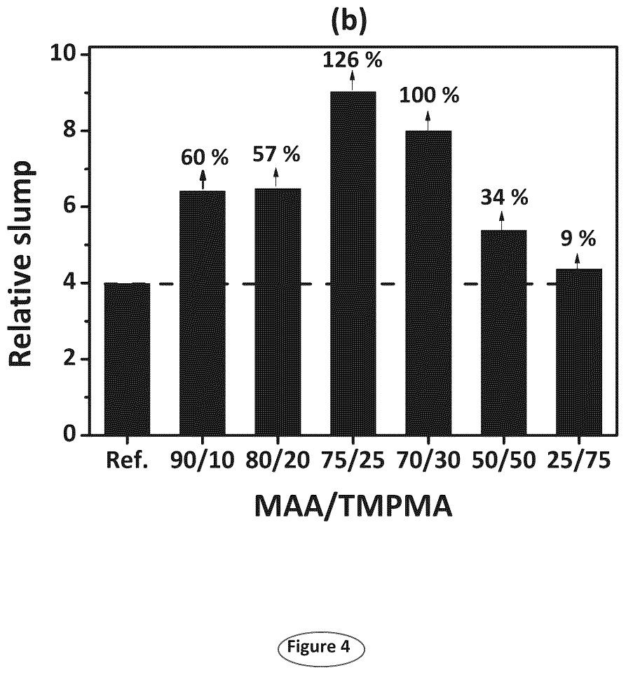

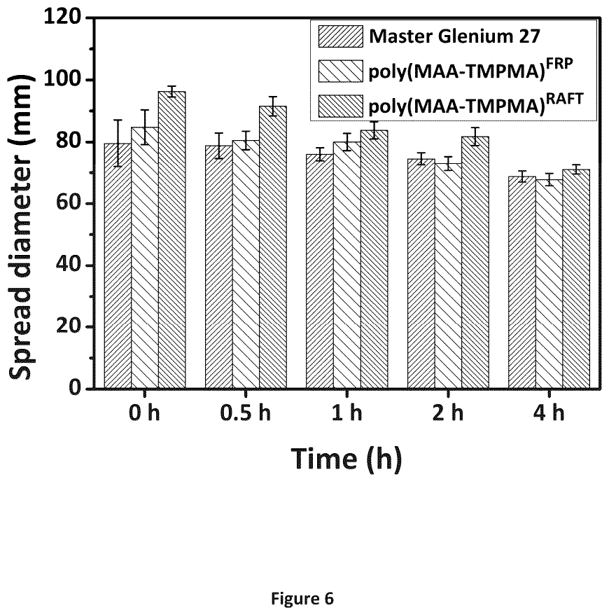

Mini-slump tests were performed to study the fluidity of the different poly(MAA-co-TMPMA) PCA superplasticizers. The obtained results are represented in FIGS. 4(a) and 4(b) for cement pastes containing 0.1% bwoc of the different PCA polymers at a w/c ratio of 0.35. The ratios mentioned in FIGS. 4(a) and 4(b) refer to theoretical MAA/TMPMA ratios in the PCA superplasticizers. The fluidity of all poly(MAA-co-TMPMA) PCA superplasticizers is significantly improved as the mini-slump diameter is significantly enhanced from 65±5 mm for the reference cement paste without superplasticizers to ˜80-94 mm in the presence of the different PCA superplasticizers, directly after mixing. When using poly(MAA₇₅-co-TMPMA₂₅) PCA with a TMPMA grafting density of 25 mol. %, the initial slump reached its highest value, which indicates the best dispersion performance. To assess the potential use of these new polymers as superplasticizers, their behavior was compared to Master Glenium 27 (commercial superplasticizer, BASF). As can be observed from FIG. 6a, the initial spread diameter of poly(MAA75-co-TMPMA25) outperforms that of Master Glenium 27 at the test dosage. The results of mini-slump correspond to the yield stress values obtained from rheological measurements where the lower the yield stress values, the greater the spread diameter, except for those polymers with negative yield stress values where this relation could not be validated.

The fluidity retention of the different PCA superplasticizers was evaluated by monitoring the fluidity loss over time for cement pastes containing 0.1% (bwoc) copolymers. From FIG. 4a, it can be seen that there is a gradual slump loss after 30 minutes and 90 minutes of water addition, whereby the mixtures with the PCA superplasticizers having a TMPMA content of 25 mol. % and 30 mol. % maintained the highest slump retention over time.

The flowability of cement pastes with different PCA superplasticizers was further assessed by comparing the relative slump values according to the following equation:

$${Γ}_{p} = {( \frac{d}{{d}_{o}} )}^{2} - 1$$

where Γₚ is the relative slump, d is the average of 4 measured diameters of the spread, and dₒ refers to the cone bottom diameter, which is 30 mm. FIG. 4b shows the relative slump results after the addition of different copolymers and mixing for 3 min. All the PCA admixtures have significantly improved the relative slump when compared to reference cement paste. The observed trend is similar to the mini-slump results with optimal performance of the PCA superplasticizers with 25-30 mol. % of TMPMA.

### 3. PCA Synthesis by Free Radical Polymerization (FRP)

Poly(MAA₇₅-co-TMPMA₂₅)^{FRP} was synthesized by FRP by copolymerization of MAA and TMPMA in an ethanol/water (70/30 vol %) solvent mixture in the presence of 3-mercaptopropionic acid as an irreversible chain transfer agent, aiming to prepare a PCA with a similar molecular weight as those prepared by RAFT polymerization. The resulting poly(MAA-co-TMPMA)^{FRP} was obtained in a high yield and quantitative monomer conversion after 3 hours. This low dispersity may be attributed to the addition of the 3-mercaptopropionic acid chain transfer agent as well as the precipitation of the formed polymers during the polymerization.

The performance of the poly(MAA₇₅-co-TMPMA₂₅)^{FRP} as PCA superplasticizer was evaluated by rheology flow curves as well as mini-slump tests.

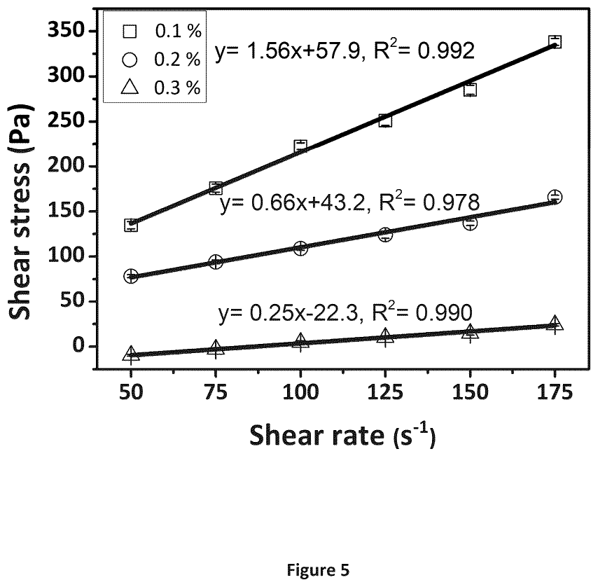

The flow curves were obtained at different copolymer dosages to explore the minimum effective dosage for better fluidity of the cement pastes (FIG. 5). The results show that, at a low polymer concentration, the yield stress is sharply decreased (i.e., from 130 Pa for blank cement paste to 58 Pa after the addition of 0.1% (bwoc) of the polymer). However, the viscosity of the paste increased significantly with increasing shear rate. Increasing the polymer dosages to 0.2 and 0.3% (bwoc) sharply reduced both the yield stress and the viscosity of the paste.

The mini-slump test is another method to assess the workability and workability retention of cement pastes by measuring the spread diameter over time. As can be seen from FIG. 6, the initial slump of the cement with 0.1% (bwoc) of poly(MAA₇₅-co-TMPMA₂₅)^{FRP} (81 mm) is lower compared to the cement with the best performing RAFT PCA (94 mm). However, the cement with poly(MAA₇₅-co-TMPMA₂₅)^{FRP} showed a more consistent slump and high slump retention over time up to 4 hours. The results of mini-slump test of polymers prepared by both FRP and RAFT are compared to Master Glenium 27. As can be seen, the synthesized polymers exhibited higher initial slump and better slump retention when compared to Master Glenium 27. These results indicate that these polymers could be effective for applications that require longer slump retention.

### Example 2

Copolymers of methacrylic acid (MAA) and 2-(diethylamino)ethyl methacrylate (DEAEMA) of equal molar ratios were prepared by free radical polymerization as follows: 8.48 g of MAA, 20.13 g of DEAEMA, and 0.27 g of AIBN were dissolved into 71.1 g N, N-dimethyl formamide (DMF). The solution was purged with N₂ for 30 minutes and then transferred to a preheated oil bath at 80° C. where the polymerization continued for three hours. The polymerization was stopped by rapidly quenching the flask into an ice bath while being exposed to air. The polymers were purified by precipitation in diethyl ethers. The pure polymers were dried in vacuo at 40° C. overnight. Different polymerization conditions were performed and, in some cases, 3-mercaptopropionic acid (MPA) was used as a chain transfer agent (CTA). The conditions and main results are summarized in Table 3.

TABLE 3
Reaction parameters and main results of
poly(MAA₅₀-co-DEAEMA₅₀) copolymers prepared by FRP technique

| Entry | Monomer | Comonomer | AIBN (wt. %) | MPA (wt. %) | Mn^{a} | Ð^{b} |
|---|---|---|---|---|---|---|
| P1 | MAA | DEAEMA | 1 | 0 | 10100 | 2.79 |
| P2 | MAA | DEAEMA | 5 | 0 | 12800 | 2.95 |
| P3 | MAA | DEAEMA | 10 | 0 | 10200 | 2.78 |
| P4 | MAA | DEAEMA | 1 | 1 | 12637 | 1.90 |
| P5 | MAA | DEAEMA | 5 | 1 | 26900 | 5.03 |
| P6 | MAA | DEAEMA | 10 | 1 | 12900 | 3.00 |
| P7 | MAA | PEGMA₅₀₀ | 1 | 1 | NA | NA |

^{a}Calculated by H₂O-Methanol SEC.
^{b}Calculated by SEC (Mn/Mw)

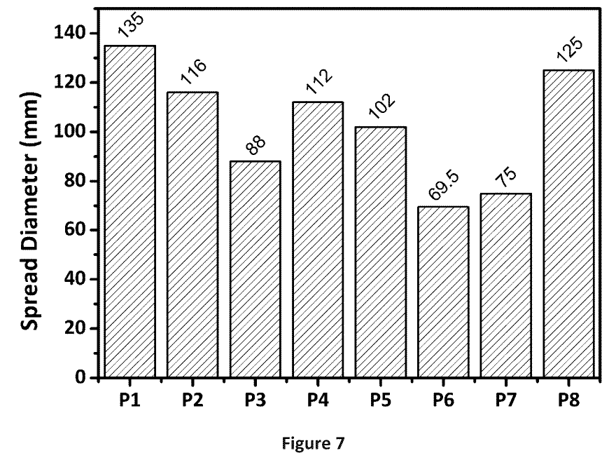

The workability of cement pastes containing any of these copolymers was assessed by a mini-slump test and was compared with a lab synthesized conventional PCE type composing MAA and PEGMA₅₀₀ at equal molar ratios (P7). The performance was also compared with a commercial PCE-type superplasticizer (i.e., Master Glenium 27; P8) and the results are shown in FIG. 7. As can be observed, all copolymers with DEAEMA, as the pendant groups, showed better fluidity than the conventional PCE-type superplasticizer, except P6. In addition, P1 showed better fluidity than Master Glenium 27 (i.e., P8), confirming that polymers according to the present disclosure show (super)plasticity and may serve as efficient cement dispersants.

1.-14. (canceled)

15. A cementitious material comprising a chemical admixture comprising a polymer, the polymer having a backbone structure, the backbone structure being provided with a plurality of negatively charged groups and having a plurality of side chains, at least portion of the side chains comprising a pendent group comprising a sterically hindered amine, with the pendent group comprising
a group of formula (I) or of formula (II) 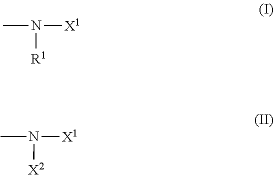
with
—X¹, —X² comprising a substituted or non-substituted alkyl having 3 to 20 carbon atoms and having a secondary or tertiary carbon atom directly attached to the nitrogen atom of the group of formula (I) or of formula (II);
—R¹ comprising hydrogen or a substituted or non-substituted alkyl having 1 to 20 carbon atoms;
or
a heterocyclic amine A comprising at least one saturated or unsaturated closed ring comprising carbon atoms and at least one nitrogen atom in the saturated or unsaturated closed ring, with the at least one nitrogen atom of the closed ring having at least one carbon atom being part of the closed ring that is directly attached to the at least one nitrogen atom and that is substituted with at least one alkyl or substituted alkyl having 1 to 20 carbon atoms,
with the negatively charged groups being present in an amount of x %, with x being at least 10, and
with the side chains comprising the sterically hindered amine being present in an amount of at least 0.80·(100−x) mol %.

16. The cementitious material of claim 15, wherein the backbone structure of the polymer has a plurality of additional side chains, with an additional side chain being a side chain not comprising a pendent group having the sterically hindered amine.

17. The cementitious material of claim 15, wherein the molar percentage of side chains comprising a pendent group having a sterically hindered amine is at least six (6) times the molar percentage of the additional side chains.

18. The cementitious material of claim 15, wherein the backbone structure does not have side chains comprising poly(ethylene oxide).

19. The cementitious material of claim 15, wherein —X¹ and/or —X² comprise a secondary alkyl, a tertiary alkyl or an isoalkyl or a substituted secondary alkyl, a substituted tertiary alkyl or a substituted isoalkyl.

20. The cementitious material of claim 19, wherein —X¹ and/or —X² comprise tertiary butyl or isopropyl.

21. The cementitious material of claim 15, wherein the closed ring of the heterocyclic amine A comprises a five- or six-membered ring structure having at least one nitrogen atom in the closed ring.

22. The cementitious material of claim 15, wherein the heterocyclic amine A comprises at least one carbon atom being part of the closed ring that is directly attached to the at least one nitrogen atom of the closed ring that is substituted with at least one methyl or ethyl group.

23. The cementitious material of claim 22, wherein the heterocyclic amine A comprises at least one carbon atom being part of the closed ring that is directly attached to the at least one nitrogen atom of the closed ring that is substituted with two methyl groups, two ethyl groups or with one methyl and one ethyl group.

24. The cementitious material of claim 15, wherein the negatively charged groups are selected from the group consisting of carboxylates, sulfonates, phosphonates and combinations thereof.

25. The cementitious material of claim 15, wherein the pendent group is linked to the backbone structure by a chemical bond or by a linking group —Z—, —Y—Y¹—Z—, —Z—Y²— or —Y¹—Z—Y²—
with
—Z— comprising a linking group of formula (IV), formula (V) or formula (VI) 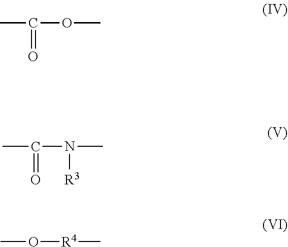
—R³ comprising hydrogen or a substituted or non-substituted hydrocarbyl having a chain and/or ring structure comprising carbon atoms and hydrogen atoms and optionally comprising at least one heteroatom;
—R⁴— comprising a substituted or non-substituted hydrocarbyl having a chain and/or ring structure comprising carbon atoms and hydrogen atoms and optionally comprising at least one heteroatom;
—Y—, —Y¹—, —Y²— comprising a substituted or non-substituted hydrocarbyl having a chain and/or ring structure comprising carbon atoms and hydrogen atoms and optionally comprising at least one heteroatom.

26. The cementitious material of claim 25, wherein the pendent group is linked to the backbone structure by a chemical bond.

27. The cementitious material of claim 25, wherein the linking group linking the pendent group to the backbone structure comprises —Z— or —Z—Y²—, with Z comprising 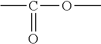
and —Y²— comprising an alkyl, a substituted alkyl, an alkenyl, a substituted alkenyl or an ethoxyalkyl.

28. A cementitious composition comprising a cementitious material and a chemical admixture, the chemical admixture comprising a polymer having a backbone structure provided with a plurality of negatively charged groups and having a plurality of side chains, the at least part of the side chains comprising a pendent group comprising a sterically hindered amine, with the pendent group comprising
a group of formula (I) or of formula (II) 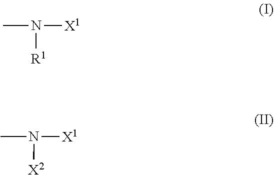
with
—X¹, —X² comprising a substituted or non-substituted alkyl having 3 to 20 carbon atoms and having a secondary or tertiary carbon atom directly attached to the nitrogen atom of the group of formula (I) or of formula (II);
—R¹ comprising hydrogen or a substituted or non-substituted alkyl having 1 to 20 carbon atoms;
or
a heterocyclic amine A comprising at least one saturated or unsaturated closed ring comprising carbon atoms and at least one nitrogen atom in the saturated or unsaturated closed ring, with the at least one nitrogen atom of the closed ring having at least one carbon atom being part of the closed ring that is directly attached to the at least one nitrogen atom and that is substituted with at least one alkyl or substituted alkyl having 1 to 20 carbon atoms;
with the negatively charged groups being present in an amount of x %, with x being at least 10, and
with the side chains comprising a pendent group having the sterically hindered amine being present in an amount of at least 0.80·(100−x) mol %.

29. A polymer having a backbone structure, wherein the backbone structure has a plurality of negatively charged groups and has a plurality of side chains, at least a portion of the side chains comprising a pendent group comprising a sterically hindered amine, with the pendent group comprising:
a group of formula (I) or of formula (II) 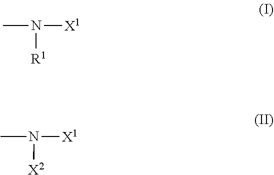
with
—X¹, —X² comprising a substituted or non-substituted alkyl having 3 to 20 carbon atoms and having a secondary or tertiary carbon atom directly attached to the nitrogen atom of the group of formula (I) or of formula (II); and
—R¹ comprising hydrogen or a substituted or non-substituted alkyl having 1 to 20 carbon atoms;
or
a heterocyclic amine A comprising at least one saturated or unsaturated closed ring comprising carbon atoms and at least one nitrogen atom in the saturated or unsaturated closed ring, with the at least one nitrogen atom of the closed ring having at least one carbon atom being part of the closed ring that is directly attached to the at least one nitrogen atom and that is substituted with at least one alkyl or substituted alkyl having 1 to 20 carbon atoms,
with the negatively charged groups being present in an amount of x %, with x being at least 10, and
with the side chains comprising the sterically hindered amine being present in an amount of at least 0.80·(100−x) mol %.

30. The polymer of claim 29, wherein the molar percentage of side chains comprising a pendent group having a sterically hindered amine is at least six (6) times the molar percentage of the additional side chains.

31. The polymer of claim 29, wherein the backbone structure has no side chains comprising poly(ethylene oxide).

32. The polymer of claim 29, wherein —X¹ and/or —X² comprise a secondary alkyl, a tertiary alkyl or an isoalkyl or a substituted secondary alkyl, a substituted tertiary alkyl or a substituted isoalkyl.

33. The polymer of claim 29, wherein the closed ring of the heterocyclic amine A comprises a five- or six-membered ring structure having at least one nitrogen atom in the closed ring.

34. The polymer of claim 29, wherein the heterocyclic amine A comprises at least one carbon atom being part of the closed ring that is directly attached to the at least one nitrogen atom of the closed ring that is substituted with at least one methyl or ethyl group.

35. A method of making the cementitious material of claim 1, the method comprising admixing, while making the cementitious material, the polymer with the cementitious material.
